(19) United States
(12) Patent Application Publication
(10) Pub. No.: US 2010/0043836 A1
(43) Pub. Date: Feb. 25, 2010

(54) Tool cleaning apparatus and method

(76) Inventor: Francis Osborn, Corfe Mullen (GB)

Correspondence Address: ROGER A. GILCREST, 250 WEST STREET, COLUMBUS, OH, 43216-7513, US

(21) Appl. No.: 12/380,061

(22) Filed: Feb. 23, 2009

(30) Foreign Application Priority Data
Mar. 14, 2008 (EP) 08250895.3

(51) Int. Cl. B08B 3/00

(52) U.S. Cl. 134/28; 134/84

(57) ABSTRACT

An apparatus and method for cleaning tools such as laminating tools used in the manufacture of glass reinforced plastic. The apparatus includes a bath having two sections, each containing a cleaning fluid such as an ester solvent and an aqueous solvent respectively, and a heating tank placed under the sections so that the solvents can be heated. In use, an operator cleans a tool in each section in turn. Additional features include a compressed air drier, filters to remove solid deposits, barriers and a bunded base to prevent spillage or leakage, and drains to remove the fluids from each section.

### RELATED APPLICATION DATA

This application is related to co-pending European Patent Application No. 08250895.3, filed Mar. 14, 2008, which is hereby incorporated in its entirety herein by reference.

### FIELD OF THE INVENTION

The present invention is directed to an apparatus and method for cleaning tools. The invention is particularly suitable for cleaning laminating tools used in the manufacture of glass reinforced plastic (GRP).

### BACKGROUND OF THE INVENTION

During GRP manufacture, laminating tools such as rollers and brushes are used to apply layers of resin to glass fibre. Traditionally, the cleaning of these tools has involved the use of the solvent acetone, which is very effective at removing resin deposits from the tools. However, a significant disadvantage of acetone is that it is volatile and highly flammable. With the high risk of an explosion should the acetone ignite, it is preferable to use a less hazardous alternative for cleaning the tools.

One such alternative which has been used in the recent past has been the refined dimethyl esters of adipic, glutaric and succinic acids, otherwise known as dibasic esters. Unlike acetone, these esters are non-volatile, biodegradable and pose no harm to users or the environment. However, whilst dibasic esters have these desirable advantages or acetone, one significant drawback of this alternative is the comparatively poor cleaning performance at ambient temperature.

### BRIEF SUMMARY OF THE INVENTION

It is an aim of the present invention to obviate or mitigate the aforementioned disadvantages.

According to a first aspect of the present invention, there is provided an apparatus for cleaning tools, the apparatus comprising:
a bath having first and second sections adapted to receive first and second cleaning fluids; and
a heating tank positioned beneath the bath, the heating tank containing a heating means adopted to heat the first and second sections of the bath.

Preferably, the apparatus further comprises at least one drying means. Preferably, the at least one drying means comprises a compressed air drier adapted to be connected to a compressed air supply.

Preferably, the heating means comprises a heating oil and a heating element extending into the tank to heat the oil. Preferably, the heating tank further comprises a pressure relief valve.

Preferably, the heating element includes a thermostat located in the heating tank. Preferably, the heating element also includes a timing device.

Preferably, the first and second sections of the bath include a removable filter means adapted to remove solid deposits from the fluids contained therein.

Preferably, the bath and heating tank are fixed to a support frame. Preferably, the frame comprises a first portion which supports the bath and heating tank, and a second lower portion adapted to firm a platform upon which an operator may stand.

In a preferred embodiment the platform extends along one longitudinal side of the bath. Alternatively, the platform may extend along two or more sides of the bath.

Preferably the apparatus further comprises a bunded based to prevent leakage of spilled fluids. The frame is located within the footprint of the base.

Preferably, each of the first and second sections of the bath includes a drain valve.

Preferably, at least one longitudinal edge of the bath includes an inclined lip potion projecting upwardly and outwardly from the bath. Preferably, the lip portion is provided with a mesh screen extending substantially horizontally towards the centerline of the bath.

Preferably, the bath includes an integral barrier member adapted to prevent fluid from spilling over a side of the bath. The barrier member is integral with a longitudinal side of the bath. Alternatively, the barrier member extends longitudinally along the centerline of the bath.

According to a second aspect of the invention, there is provided a method of cleaning tools, comprising:
providing a cleaning apparatus in accordance with the first aspect of the invention;
filling the first section of the bath with an ester solvent fluid;
filling the second section of the bath with an aqueous solvent fluid;
heating the fluids in the first and second sections;
cleaning a tool first in the heated ester solvent fluid and subsequently in the aqueous solvent fluid.

Preferably, the method further comprises draining the tool of fluid following each cleaning step.

Preferably, the method further comprises a final step of drying the tool using compressed air.

Preferably the ester solvent fluid includes a dibastic ester.

### BRIEF DESCRIPTION OF THE DRAWINGS

Preferred embodiments of the invention will now be described, by way of example only, with reference to the accompanying drawings, in which:

FIG. 1 is a perspective view of a first embodiment of a tool cleaning apparatus;

FIG. 2 is a plan view of the apparatus shown in FIG. 1;

FIG. 3 is an end view of the apparatus showing in FIG. 1; as presented by arrow III in FIG. 2.

FIG. 4 is a side view of the apparatus shown in FIG. 1;

FIG. 5 is an end view of the apparatus showing In FIG. 1; as presented by the arrow V in FIG. 2;

FIG. 6 is a perspective view of a second embodiment of a tool cleaning apparatus;

FIG. 7 is a plan view of the apparatus shown in FIG. 6;

FIG. 8 is an end view of the apparatus of FIG. 6; as represented by the arrow VIII in FIG. 7;

FIG. 9 is a side view of the apparatus shown in FIG. 6; and

FIG. 10 is an end view of the apparatus shown in FIG. 6, represented by the arrow X in FIG. 7.

### DETAILED DESCRIPTION OF THE PREFERRED EMBODIMENTS

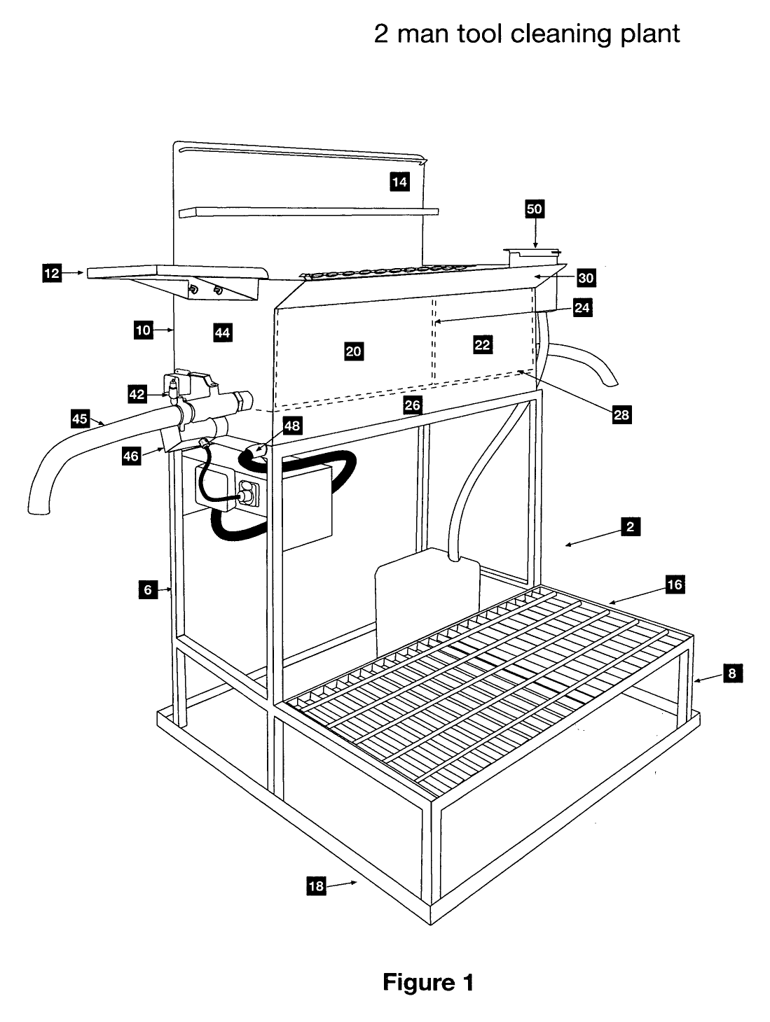

FIGS. 1-5 show various views of a first embodiment of a tool cleaning apparatus, generally designated 2. The apparatus comprises a frame 4, which is divided into a first and second frame portions 6, 8. Each frame portion 6, 8 includes two pairs of legs extending substantially vertically. The legs of the first frame portion 6 are longer than those of the second frame portion 8, with the result that the first frame portion 6 is elevated relative to the second frame portion 8. Fixed to the top of the first frame portion 6 is a bath 10. Preferably, the bath 10 has a tray member 12 fixed to a first end thereof and a barrier member, or splashback, 14 fixed along one side of the bath 10 to prevent any liquids contained in the bath from spilling over the rear of the bath 10. Fixed to the top of the second frame portion 8 is a footplate, or grille, 16. The combination of the second frame portion 8 and the footplate 16 forms a platform on which one or more operatives will stand when using the bath 10. The frame 4 sits within a bunded base 18 which prevents any spilt liquids from leaving the area of the apparatus 2.

The bath 10 is divided into two sections 20, 22 which are open to atmosphere and separated by a first dividing wall 24 which extends laterally across the bath 10. A heating tank 26 lies beneath the bath sections 20, 22 and is defined by the walls of the bath 10 and a second dividing wall 28 which separates the heating tank 26 from the first and second sections 20, 22. The heating tank 26 lies beneath the first and second sections 20, 22 such that the second dividing wall 28 forms both the base of the first and second sections 20, 22 and the top of the heating tank 26.

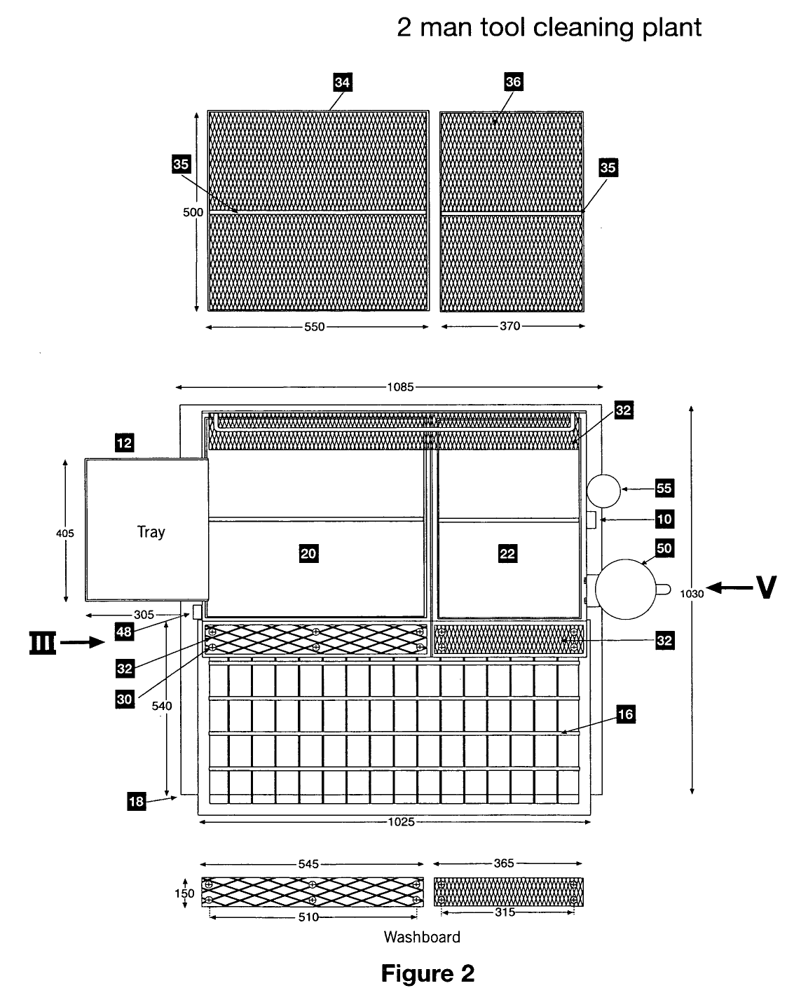

As best seen in FIGS. 1, 3 and 5, an upwardly and outwardly projecting lip 30 is formed at the top of the side of the bath 10 adjacent the platform. The lip 30 results in the circumference of the top of the bath 10 being greater than the circumference of the base of the bath 10. As seen in FIG. 2, one or more mesh screens 32 are fixed to the lip 30 and extend substantially horizontally from the lip 30 towards the centerline of the bath 10. Tools which have been soaked in the bath 10 can be squeezed through the mesh screen 32 such that any liquid drained from the tools is retained in the bath 10. The barrier member 14 at the rear of the bath may also have one or more mesh screen 32 extending therefrom.

FIG. 2 also illustrates a pair of removable filter trays 34, 36 which can be intermittently placed in the first and second sections 20, 22 in order to remove any large deposits of material which have been cleaned from the tools but remain in the liquid in the sections 20, 22. Each tray has a handle 35 and a mesh, or apertured, base. Thanks to the base, when the trays 34, 36 are removed from the sections 20, 22 they pick up any sizable deposits by tallow any liquid to drain back into the sections 20, 22.

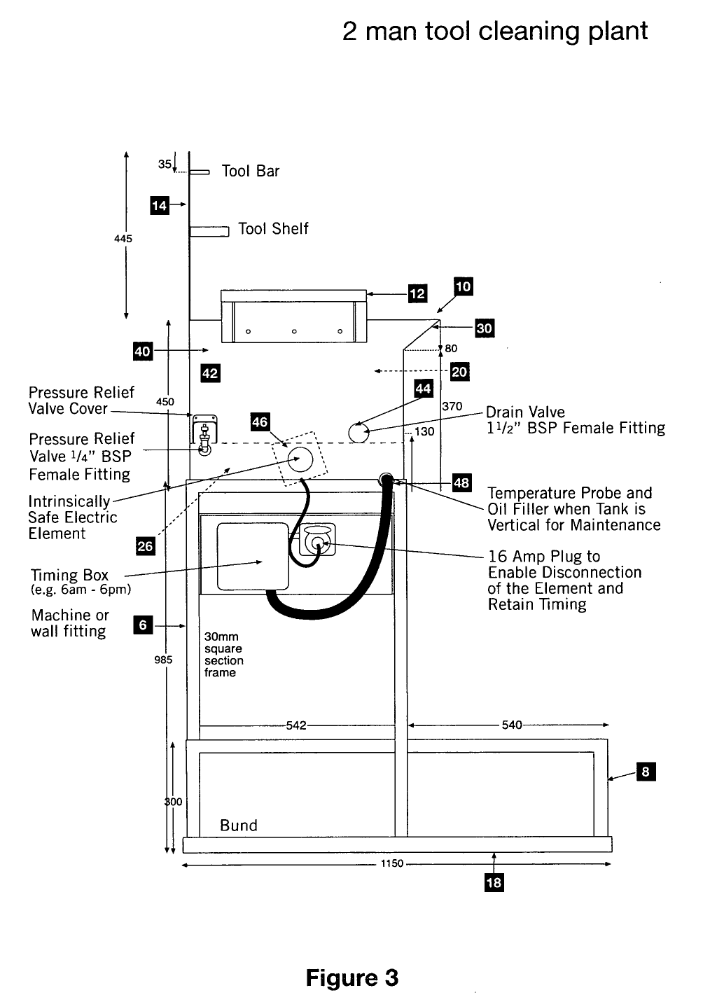

FIG. 3 shows a first end 40 and the bath 10. The first end 40 accommodates a pressure relief valve 42 for relieving pressure in the heating tank 26, and a first drain valve 44 to which a drain hose 45 (as seen best in FIG. 1) may be connected. The first drain valve 44 is adapted to drain the first section 20. Also provided at the first end 40 is an electrical heating element 46 projecting into the heating tank 26, and a second drain valve 48 adapted to drain the heating tank 26.

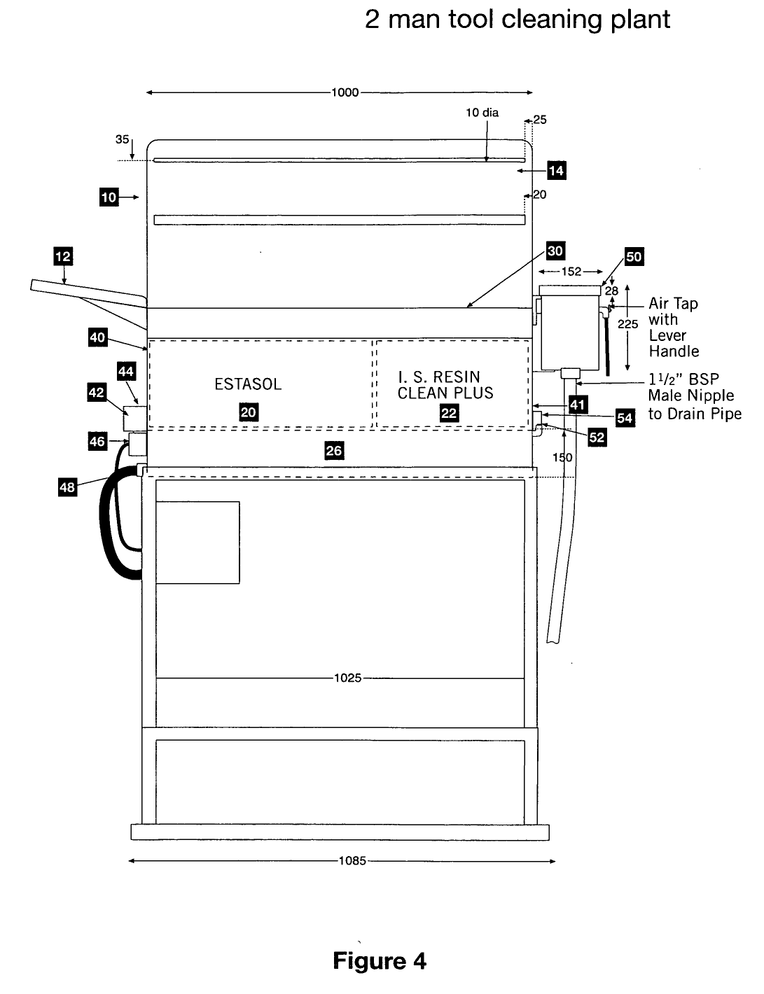

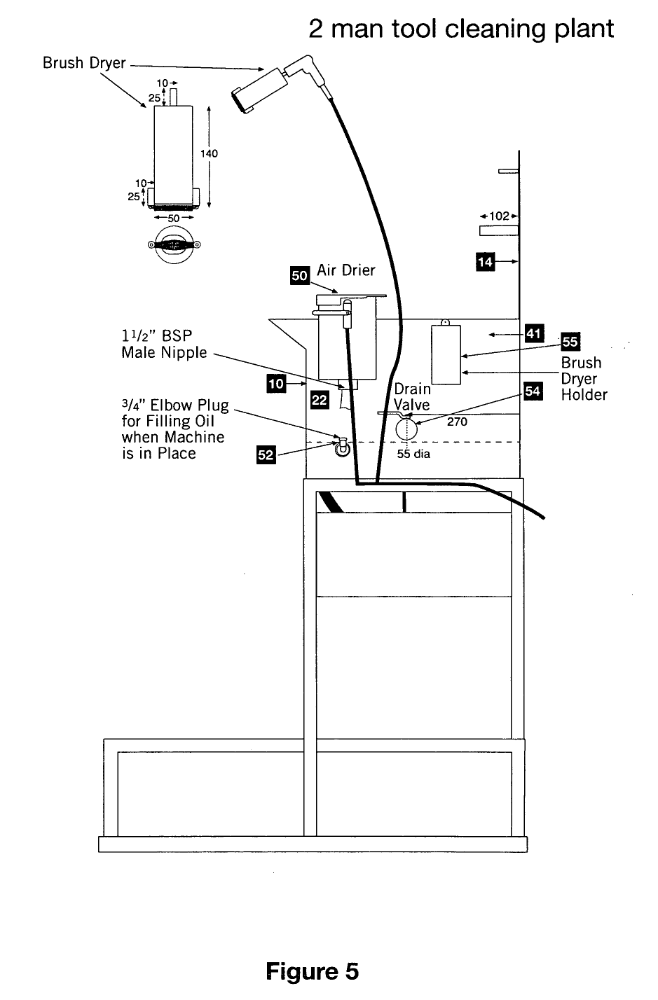

FIG. 4 shows a side view of the bath 10 and the various components described above. FIG. 4 also illustrates a compressed air drier 50 which is attached to the second end 41 of the bath, which itself is seen best in FIG. 5. The second end 41 also accommodates a filler port 52 adapted to permit filling of the heating tank 26, and a third drain valve 54 adapted to permit the draining of the second section 22.

The method of operation of the first embodiment shown in FIGS. 1-5 will now be described. Initially, the sections 20, 22 of the bath 10 are filled with their respective cleaning fluids. The first section 20 is the larger of the two and is filled with an ester solvent mixture, while the smaller second section 22 is filled with an aqueous solvent mixture. The ester solvent mixture preferably includes a dibasic ester. An example of a suitable solvent is Estasol® as manufactured by Haltermann Products of Hamburg, Germany. The cleaning fluids are poured directly into the open tops of the section 20, 22.

If it is not already filled, the heating tank 26 is also filled at this time via filler port 52. The heating tank 26 is preferably filled with heating oil. The heat is generated by the intrinsically safe electrical element 46 which projects into the heating tank 26. The element 46 can either be controlled manually via an on/off switch, or else a timer is provided so that the oil is only heated during certain time periods.

The electrical element 46 also has a thermostat (not shown) which controls the temperature of he oil in the heating tank 26. The thermostat is preferably set to maintain the oil temperature at approximately 50 deg C. Heat from the oil is transferred to the fluids in the first and second sections 20, 22 via the second dividing wall 28. It has been found by the applicant that heating the oil to approximately 50 deg C. results in a temperature of approximately 35 deg C. for the fluids in the first and second sections 20, 22. The air drier is also connected to a supply of compressed air at a minimum of 80 psi.

Should the thermostat fail and the electrical element 46 increase in the bath temperature, the temperature probe (circuit breaker) 48 will detect at 55 deg C. and shut down the element.

Once the fluids have been heated, an operator can begin cleaning tools. In the first instance, the operator will clean the tools in the first section 20 containing the ester solvent mixture. The tools are then preferably squeezed against the mesh screen 32 by the operator to drain any cleaning fluids back into the first section 20. The process is then repeated by the operator using the aqueous solution within the second section 22. Once the tools have been cleaned and drained using both cleaning fluids, the tools are preferably dried using the air drier 50. The drying of the tools ensures that any liquid present is removed and the tools are ready for reuse as quickly as possible. If any liquid was retained by the tools, this could have an adverse effect on any laminating procedures undertaken with those tools.

As explained above, large deposits of resin which have been cleaned from the tools can be removed from the sections 20, 22 using the removable filter trays 34, 36. The operator can choose to top up the fluids in each section 20, 22 to maintain the maximum cleaning efficiency, or else the fluids can be drained into drums via the respective drain valves 45, 54 and replaced with fresh fluids.

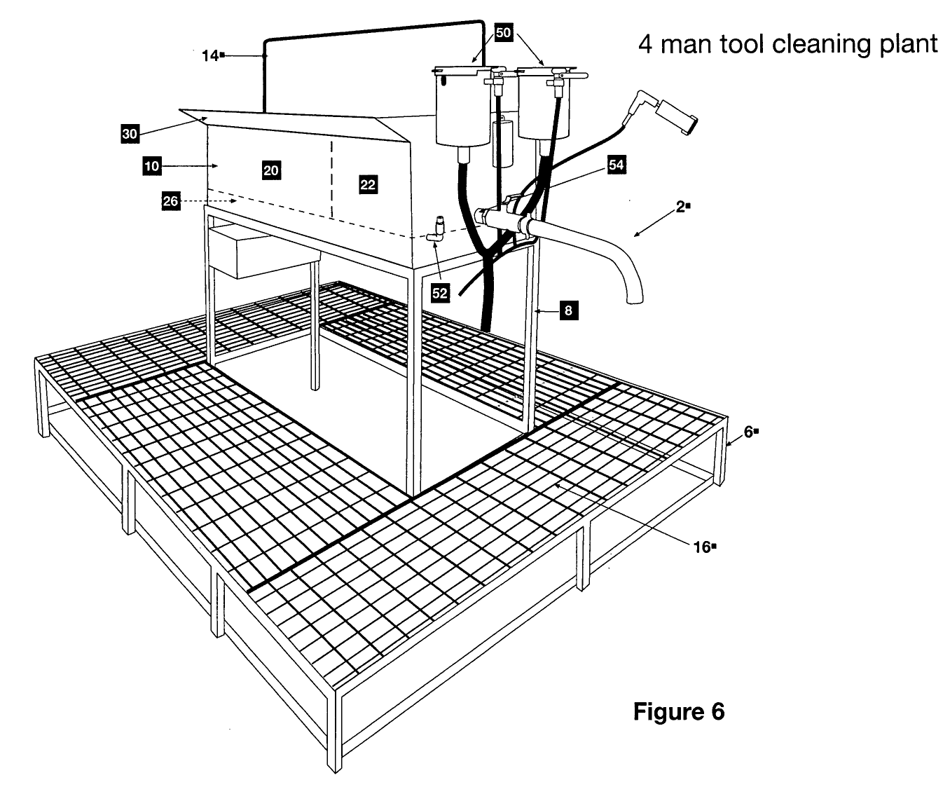

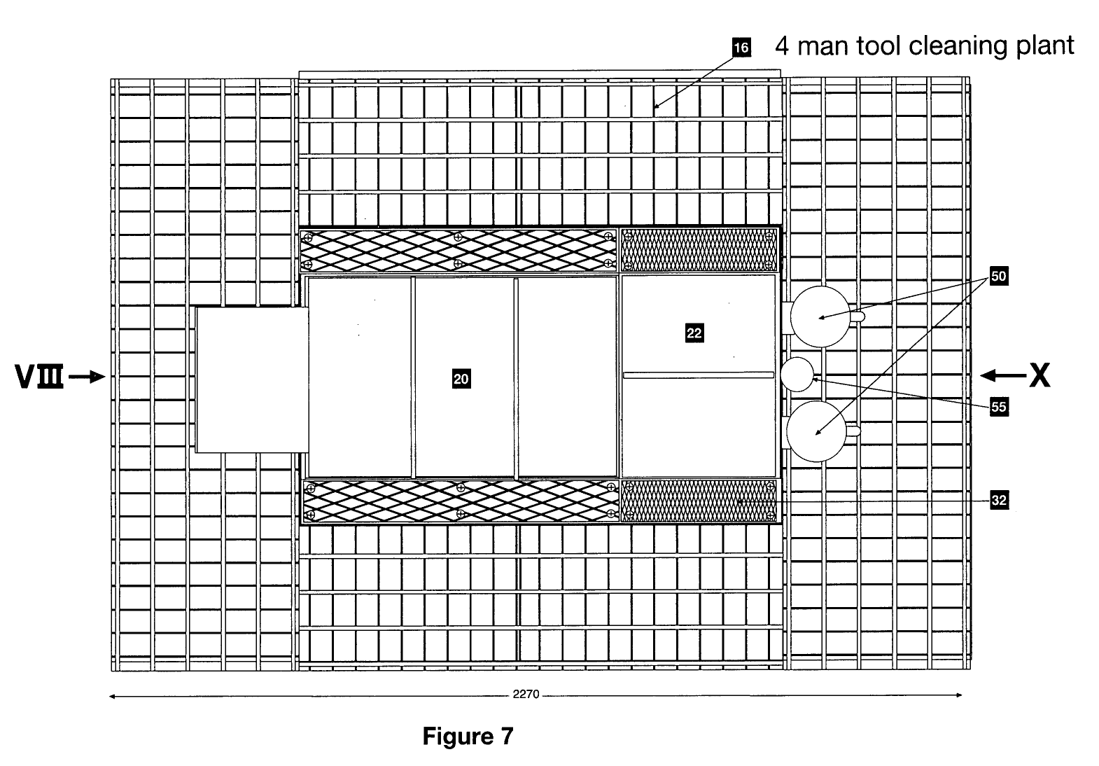

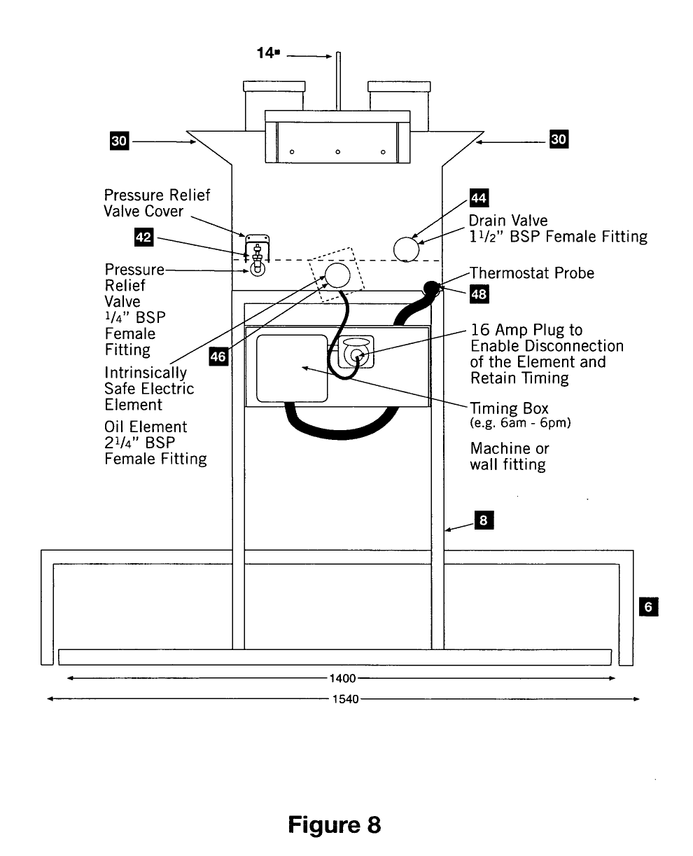

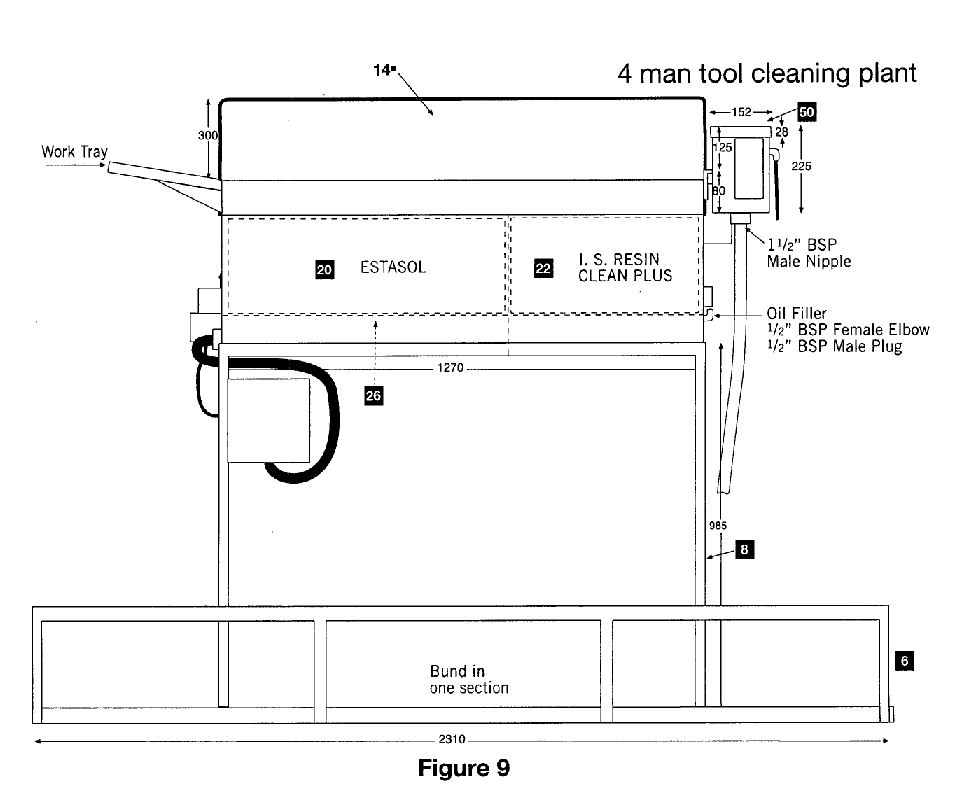

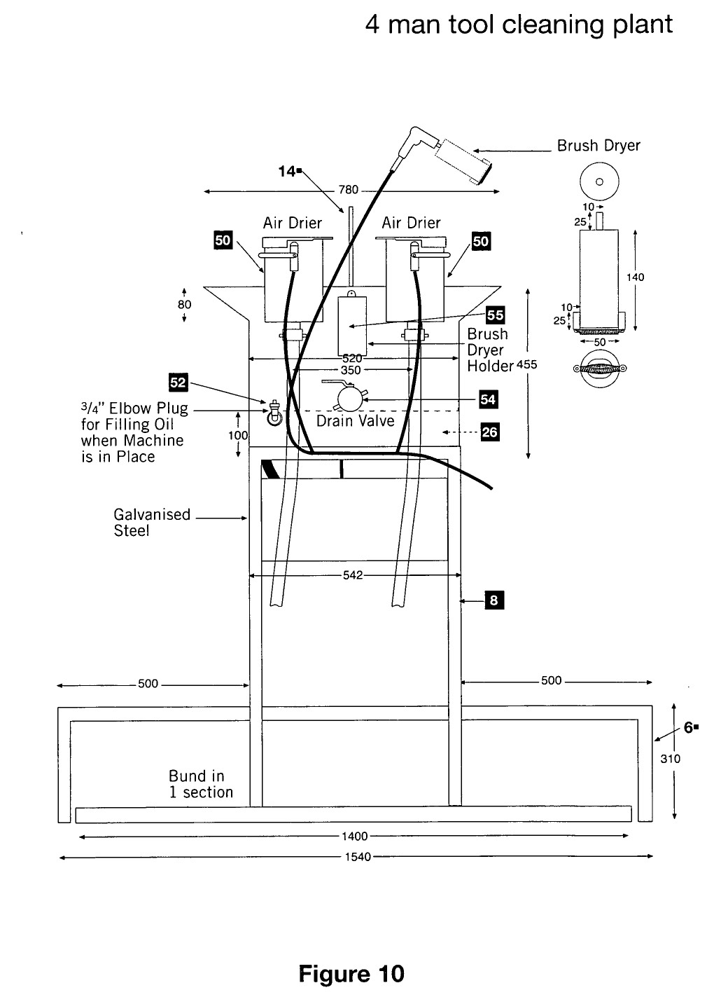

FIGS. 6-10 illustrate a second embodiment of the present invention. Whereas the first embodiment of the apparatus 2 was intended for use by one or two operators, the second embodiment, generally, designated 2, can be used by a greater number of operators. The apparatus is substantially the same as that of the first embodiment, although several modifications have been made to accommodate additional operators. The second frame portion 6 and associated footplate 16 extend around at least two sides, and preferably the entire circumference, of the bath 10. To facilitate this further, the barrier/splashback has been moved such that it extends longitudinally along the centre of the bath 10 and both sides of the bath 10 include a lip 30 and associated mesh screens 32. Each end 40, 41 of the bath 10 accommodate the same components as the first embodiment, with the exception that a pair of air driers 50 is now provided on the second end 41.

The apparatus 2 is filled, drained and operated in the same manner as the first embodiment described above.

The present invention provides an apparatus and method for cleaning laminating tools which does without the need for volatile organic chemicals such as acetone. Furthermore, thanks to the direct heating of the sections containing the cleaning fluids, the cleaning performance of the non-volatile ester solvent mixture is improved.

Preferably, the drain valves for each of the three sections are ball valve arrangements. The apparatus is provided with a residual current device and earthing for electrical protection.

Preferably, the frame, bunded base and footplates are manufactured from galvanized steel. Preferably, the bath and associated components are manufactured from stainless steel.

The division of the total possible volume of he first and second sections of the bath is preferably 60:40 in favour of the first section, which is consequently 1.5 times the size of the second section. Alternatively, the division may be 70:30 in favour of the first section.

Modifications and improvement may be incorporated without departing from the scope of the invention.

What is claimed is:

1. An apparatus for cleaning tools, the apparatus comprising:
a bath having first and second sections adapted to receive first and second cleaning fluids; and
a heating tank positioned beneath the bath, the heating tank containing a heating means adapted to heat the first and second sections of the bath.

2. An apparatus according to claim 1 wherein the apparatus further comprises at least one drying means.

3. An apparatus according to claim 2 wherein the at least one drying means comprises a compressed air drier adapted to be connected to a compressed air supply.

4. An apparatus according to claim 1 wherein the heating means comprises a heating oil and a heating element extending into the tank to heat the oil.

5. An apparatus according to claim 4 wherein the heating element includes a thermostat located in the heating tank.

6. An apparatus according to claim 1 wherein the first and second sections of the bath include a removable filter means adapted to be remove solid deposits from the fluids contained therein.

7. An apparatus according to claim 1 wherein the bath and heating tank are fixed to a support frame, the frame comprises a first portion which supports the bath and heating tank, and a second lower portion adapted to form a platform upon which an operator may stand.

8. An apparatus according to claim 7 wherein the apparatus further comprises a bunded base to prevent leakage of spilt fluids and the frame is located within the footprint of the base.

9. An apparatus according to claim 1 wherein each of the first and second sections of the bath includes a drain valve.

10. An apparatus according to claim 1 wherein at least one longitudinal edge of the bath includes an inclined lip portion projecting upwardly and outwardly from the bath.

11. An apparatus according to claim 10 wherein the lip portion is provided with a mesh screen extending substantially horizontally towards a centreline of the bath.

12. An apparatus according to claim 1 wherein the bath includes an integral barrier member adapted to prevent fluid from spilling over a side of the bath.

13. A method of cleaning tools, comprising:
providing a cleaning apparatus according to claim 1; filling the first section of the bath with an ester solvent fluid;
filling the second section of the bath with an aqueous solvent fluid; heating the fluids in the first and second sections;
cleaning a tool first in the heated ester solvent fluid and subsequently in the aqueous solvent fluid.

14. A method according to claim 13 wherein the method further comprises draining the tool of fluid following each cleaning step.

15. A method according to claim 13 wherein the method further comprises a final step of drying the tool using compressed air.

16. A method according to claim 13 wherein the ester solvent fluid includes a dibasic ester.
